(19) United States
(12) Patent Application Publication
(10) Pub. No.: US 2006/0158886 A1
(43) Pub. Date: Jul. 20, 2006

(54) Illuminated bowl

(76) Inventor: Kyu-Woong Lee, Milpitas, CA (US)

Correspondence Address: KYU-WOONG LEE, 199 BALBOA DR, MILPITAS, CA, 95035, US

(21) Appl. No.: 11/035,858

(22) Filed: Jan. 14, 2005

(51) Int. Cl. F21V 9/12

(52) U.S. Cl. 362/318; 362/652; 362/253; 362/234

(57) ABSTRACT

Illuminated bowl with an inner bowl, an outer bowl constructed of sand blasted translucent glass or plastic, the inner and outer bowl being fused together at their top perimeter edge forming a hollow cavity. The hollow cavity is filled with a magnifying liquid such as mineral oil. A power supply such as a battery, a switch, a plurality of colored LED's, a battery door are contained within a depression located on the underside of the outer bowl. The LED's are aimed at the hollow cavity filled with magnifying liquid causing the outer bowl to be illuminated and to glow evenly throughout the body of the bowl. A preferred embodiment includes the inner bowl is also made of translucent material such as sand blasted plastic or glass causing the inner bowl to glow evenly.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of food retaining bowls and more specifically to an illuminated bowl.

Bowls for holding either liquid or solid foods have been in use for thousands of years. They are traditionally made of hard materials such as metal, glass, wood, plastic or ceramic.

Traditionally, designers of bowls look for and find ways to create novel designs to the shape of the bowls and to the decorative nature of the inside and outside of the bowl. However, to the best of my knowledge, no designer has to date developed a novel bowl that, upon viewing, appears to be illuminated and to glow evenly.

### BRIEF SUMMARY OF THE INVENTION

The primary object of the invention is to provide a bowl for dinnerware purposes that is illuminated.

Another object of the invention is to provide an illuminated bowl that glows evenly throughout the body of the bowl.

Another object of the invention is to provide an illuminated bowl whose body glows evenly inside and out.

A further object of the invention is to provide an illuminated bowl that requires no outside power supply.

Yet another object of the invention is to provide an illuminated bowl whose illuminating source and power supply are concealed within the body of the bowl.

Another object of the invention is to provide an illuminated bowl that can be adjusted to change in color and intensity of illumination.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an illuminated bowl comprising: an inner bowl, an outer bowl constructed of sand blasted translucent glass or plastic, said inner and outer bowl being fused together at their top perimeter edge forming a hollow cavity, said hollow cavity filled with a magnifying liquid such as mineral oil, a power supply such as a battery, a switch, a plurality of colored LED's, a battery door, said battery, switch and LED's contained within a depression located on the underside of said outer bowl, a closure plate for said depression and said LED's aimed at said hollow cavity filled with magnifying liquid causing said outer bowl to be illuminated and to glow evenly throughout the body of said bowl.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the bowl of the invention.

FIG. 2 is a side section view of the invention.

FIG. 3 is a bottom view of the bowl of the invention.

FIG. 4 is perspective view of a removable light source version of the invention.

FIG. 5 is a side section view of the removable light source version of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

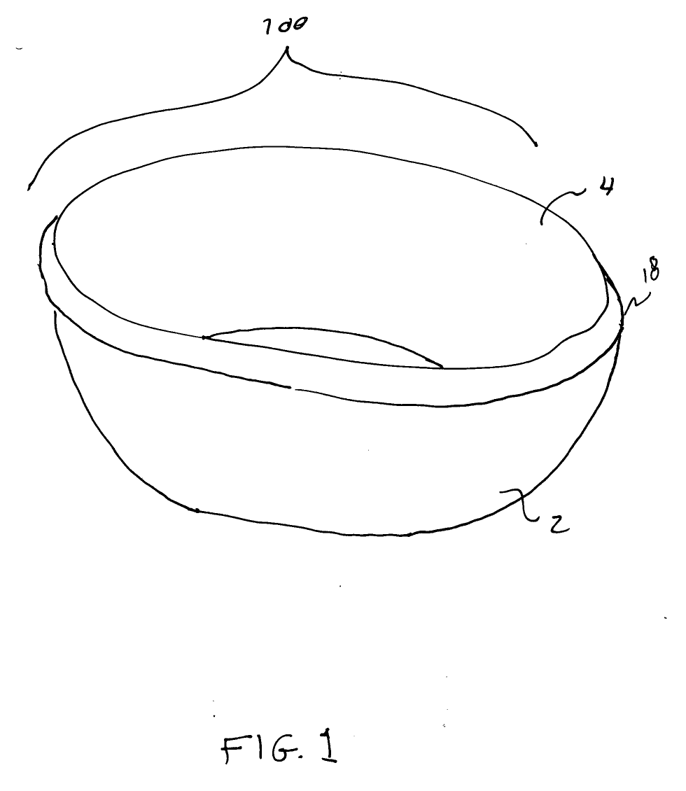

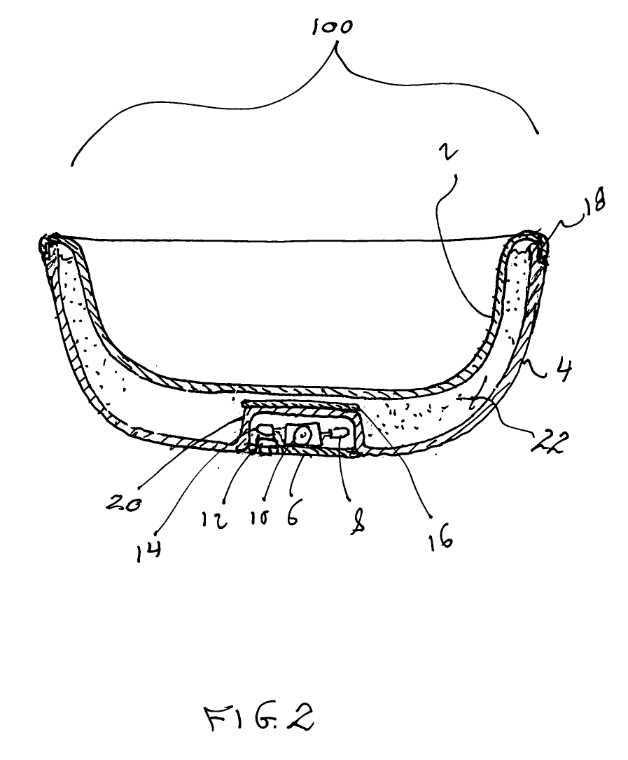

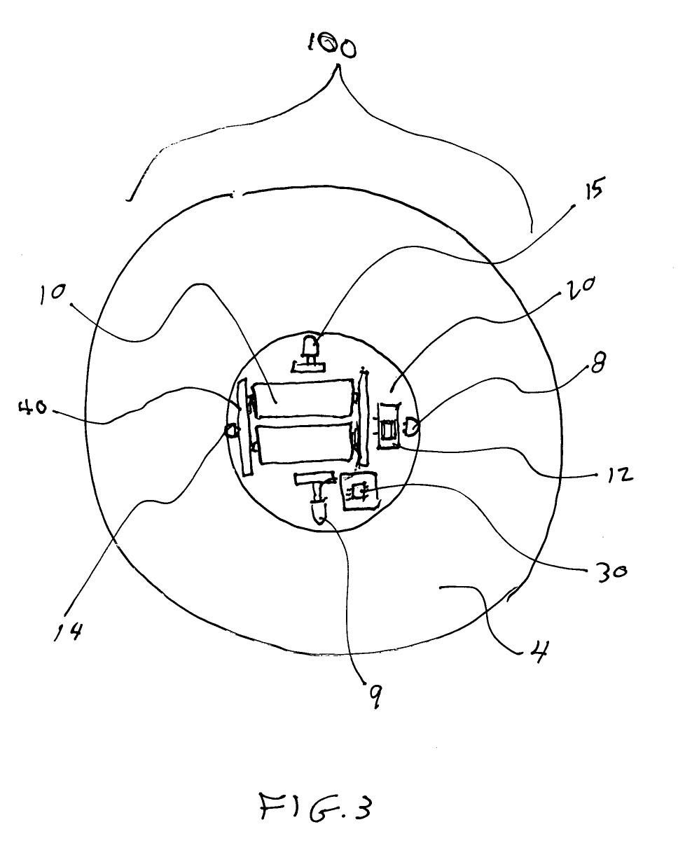

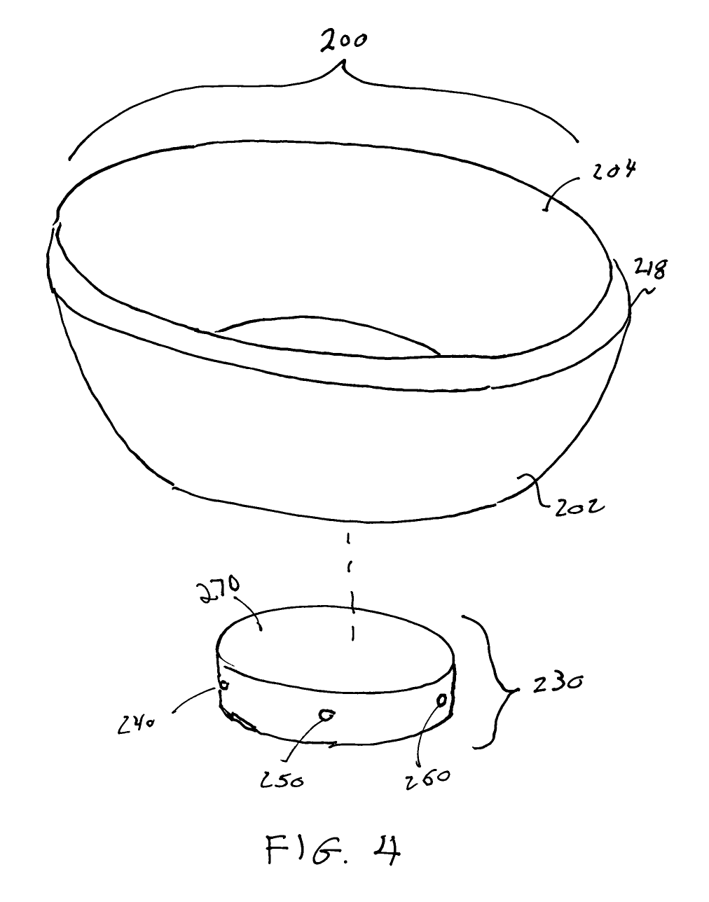

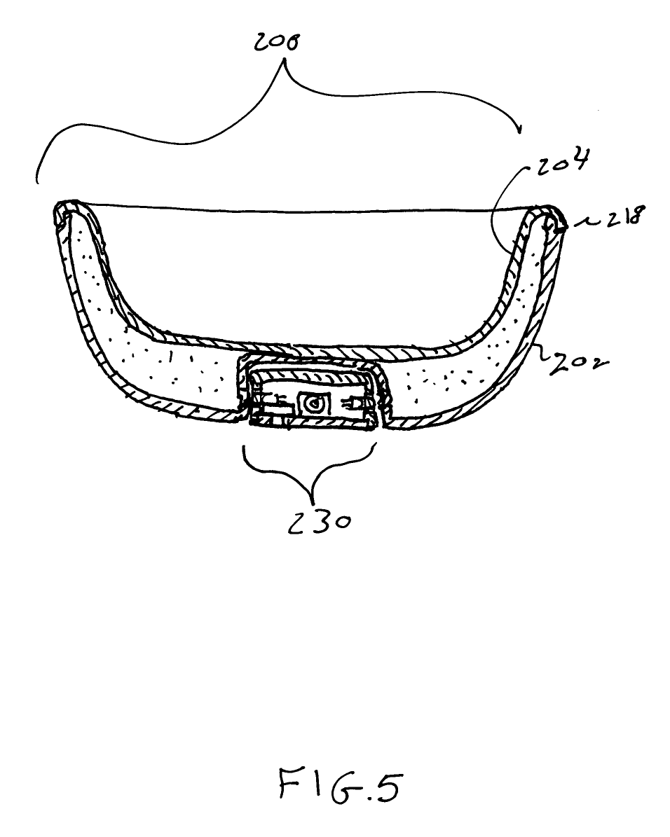

Referring now to FIG. 1 we see a perspective view of the illuminated bowl 100 of the present invention. The bowl looks more or less like a conventional bowl that is commonly used to retain a variety or foods weather liquid or solid. The bowl 100 consists of an inner bowl 4 and an outer bowl 2 that are both fused near the top peripheral edge 18. FIG. 2 shows a side section view of the invention 100. The outer bowl 4 is constructed of a transparent material such as plastic or glass that has been made translucent by sand blasting or other known similar process. The inner bowl 2 may also be made of transparent sand blasted material or it may be constructed of opaque material. The outer bowl 4 has a depression 20 at its bottom that retains a plurality of colored LED's 8, 14 as well as a switch 12 and a power supply 10 such as a battery or batteries. A closure plate 6 protects the contents of the depression 20 from unintentional contact. Because the illuminating means are contained within the depressed area 20, the bowl 4 looks conventional to the untrained eye thereby heightening the element of surprise regarding the glowing nature of the bowl 4. The hollow cavity between the inner bowl 2 and outer bowl 4 is filled with a transparent magnifying liquid such as mineral oil which I have found to be effective to the even dispersment of light emanating from LED's 8, 12. When the user activates switch 12, LED's 8, 12 are turned on. The LED's are aimed into the hollow area where mineral oil 22 resides. The mineral oil or similar transparent liquid has the effect of evenly distributing the LED light throughout the body of the bowl 100. An alternate embodiment of the outer bowl 2 can have portions of the outer surface sand blasted and other portions left transparent. The sand blasted portions glow more than the transparent portions. Opaque plate 16 prevents direct observation of the LED's by a viewer. FIG. 3 is a bottom view of the outer bowl 4. In this view the closure disk 6 is removed revealing the contents of depression 20. In this embodiment I show four LED's 8, 9, 14, 15, however there can be more or less used. The batteries 10 are shown within a standard battery holder. Standard switch 12 is shown. Also, in this embodiment, I show a micro-processor chip 30 that can control the duration and intensity of each LED. In this way, a variety of color combinations can be obtained in a variety of intensities. FIG. 4 shows a perspective view of an alternated embodiment 200 where the entire light assembly 230 can be removed from the underside of the bowl 202 so that the bowl assembly 202, 204 can be put in the dish washer without exposing the light source and related components to hot water. LED's 240, 250, 260 are able to shine through housing 270 because the housing is made of transparent plastic. FIG. 5 shows a side section view of alternate embodiment 200. The components inside the light source assembly 230 are the same as in the preferred embodiment except that the entire assembly 230 is removable and replaceable.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Illuminated bowl comprising:
an inner bowl;
an outer bowl constructed of sand blasted translucent glass or plastic;
said inner and outer bowl being fused together at their top perimeter edge forming a hollow cavity;
said hollow cavity filled with a magnifying liquid such as mineral oil;
a power supply such as a battery;
a switch;
a plurality of colored LED's;
a battery door;
said battery, switch and LED's contained within a depression located on the underside of said outer bowl;
a closure plate for said depression and
said LED's aimed at said hollow cavity filled with magnifying liquid causing said outer bowl to be illuminated and to glow evenly throughout the body of said bowl.

2. Illuminated bowl as claimed in claim 1 wherein said inner bowl is also made of translucent material such as sand blasted plastic or glass causing said inner bowl to glow evenly.

3. Illuminated bowl as claimed in claim 1 further comprising an opaque disk that is fixed on top of said bowl depression thereby restricting the light from said LED's so that it does not directly travel up to the user's eyes.

4. Illuminated bowl as claimed in claim 1 further comprising an electronic circuit that can adjust the output of said LED's to various combinations and intensities.

5. An alternate embodiment of illuminated bowl as claimed in claim 1 wherein the lighting assembly is housed in a separate housing which is removable and replaceable from said depression in said outer bowl bottom.

6. An alternate embodiment of illuminated bowl as claimed in claim 1 wherein said outer bowl is selectively sand blasted thereby creating a pattern of glowing portions and non glowing portions.
